(19) United States
(12) Patent Application Publication
(10) Pub. No.: US 2023/0401644 A1
(43) Pub. Date: Dec. 14, 2023

(54) SYSTEMS AND METHODS FOR CONDUCTING MASS MARKET HOLISTIC LOAN OPTIMIZATION

(71) Applicant: Apriority Financial, Inc., Wilmington, DE (US)

(72) Inventors: Michael Willcox, Wilmington, DE (US); Bret Rietow, Wilmington, DE (US); Brede Kolsrud, Wilmington, DE (US)

(21) Appl. No.: 18/208,657

(22) Filed: Jun. 12, 2023

Related U.S. Application Data
(60) Provisional application No. 63/351,530, filed on Jun. 13, 2022.

(51) Int. Cl. G06Q 40/06; G06Q 40/03

(52) U.S. Cl. CPC G06Q 40/06; G06Q 40/03

(57) ABSTRACT

Various aspects of the present disclosure are directed towards devices, systems, and methods for optimizing debt portfolio by actively monitoring for rate quotes from one or more lenders and performing real-time optimization to determine global optimum parameters in order for the user to be qualified for the optimal loan product that meets the user's goals.

### CROSS REFERENCE TO RELATED APPLICATION

The present application claims the benefit of U.S. Provisional Application No. 63/351,530, filed Jun. 13, 2022, the disclosure of which is incorporated herein in its entirety for all purposes.

### TECHNICAL FIELD

The present disclosure relates to loan optimization, and more particularly to optimizing an individual loan application and debt portfolio in a way that minimizes the borrower's cost of carrying the debt.

### BACKGROUND

Applying for loans can be a complicated task when there are hundreds of different lenders in the market, each with its own set of tens or hundreds of distinct loan products, e.g., 30-year fixed, 7/1 adjustable rate mortgage (ARM), etc. These products' pricing changes frequently sometimes multiple times a day for each lender. Each product has its own associated rate, often compounded monthly, but herein used interchangeably with the more familiar metric annual percentage rate (APR).

Presently, borrowers are advised to “shop around” for rates. To do so, borrowers must go through one or more mortgage brokers or mortgage bankers who are tasked with finding them the best deal, e.g., the lowest rate for a given closing cost. These brokers utilize various software interfaces to input the borrower's parameters such as loan amount (e.g., purchase price minus down payment, or payoff balance of existing loan), borrowers' credit scores, property address, type, and value, other debt obligations, and several other parameters. From this one group of inputs, a list of available products is presented to the borrower and ineligible products are hidden from view.

However, the aforementioned method or process may not allow borrowers to find the best loan product in view of the various factors which affect the pricing of the products. As such, there is a need for a system which can globally and holistically optimize the loan product applications.

### SUMMARY

Various aspects of the present disclosure are directed towards devices, systems, and methods for holistically optimizing debt portfolio by actively and automatically monitoring loan product pricing (e.g., rate quotes or rate sheets) from one or more lenders and automatically performing real-time optimization to determine global optimum parameters together with the optimal loan product that best meets the user's goals.

According to some embodiments, methods for computer-implemented debt portfolio optimization are disclosed herein. The method is implemented via one or more processors, and the method includes: acquiring, by the one or more processors, a user data profile associated with a user, wherein the user data profile includes income, credit score, assets, and a debt portfolio including existing liabilities held by the user; obtaining, by the one or more processors, a plurality of rate quotes in response to acquiring the user data profile; activating, by the one or more processors, an optimizer engine to perform optimization to obtain an optimized result based on the user data profile and the rate quotes acquired from the continuous scanning; and notifying, on a user interface of a user device, the user of the optimized result, wherein the optimized result includes an optimum loan product or an optimum loan portfolio as determined by the optimizer engine.

In some examples, the plurality of rate quotes are obtained, by the one or more processors, using a design of experiments (DOE) algorithm. In some examples, the DOE algorithm is performed based on existing loans associated with the user. In some examples, the DOE algorithm is performed further based on at least one additional loan as suggested by the processor using the DOE algorithm. In some examples, the DOE algorithm uses a loan request with parameters (e.g., one or more loan parameters) that are intentionally different from those as acquired in the user data profile, such as by varying parameter(s) associated with existing loan(s) and/or the newly requested loan(s) within a certain degree to experiment how the difference affects the optimum loan product that may be offered, for example. The user data profile may include a new loan request from the user. In some examples, the DOE algorithm is performed based on at least one additional loan as requested by the user. In some examples, the DOE algorithm is performed further based on existing loans associated with the user. In some examples, the DOE algorithm may use asset balances to adjust loan amounts, which may include restructuring, eliminating, and/or consolidating one or more loan(s) such as the new loan(s) and/or existing loan(s). In some examples, the assets include at least one property owned by the user or at least one bank and investment account associated with the user. In some examples, the existing liabilities include one or more of: mortgage, auto loan, personal loan, student loan, or credit card debt associated with the user. In some examples, the plurality of rate quotes are obtained, by the one or more processors, by continuously scanning a lender space for rate sheets from one or more lenders to process into the plurality of rate quotes and using the DOE algorithm. In some examples, the lender space comprises at least 100 lenders each offering a plurality of different loan products.

In some examples, the plurality of rate quotes are obtained, by the one or more processors, using a fitted numerical model that is trained on previously-obtained rate quote data. In some examples, the acquiring of the user data profile is triggered by a change to a value within the user data profile, the value including one or more of: an account balance, credit score, new loan, or property value. In some examples, the acquiring of the user data profile is repeatedly performed on a predetermined timeframe or a predetermined date schedule to continuously update one or more values within the user data profile. In some examples, the acquiring of the user data profile is manually performed by the user changing one or more values within the user data profile. In some examples, the plurality of rate quotes are obtained immediately in response to detecting a change to the user data profile. In some examples, the plurality of rate quotes are obtained immediately in response to detecting a triggering market event occurs. In some examples, the triggering market event includes a parameter that is capable of influencing the rate quotes. In some examples, the optimization engine is configured to perform the optimization based on one or more existing loans of the user, wherein loan balances of the one or more existing loans are restructured, eliminated, or consolidated. In some examples, the optimization engine is configured to perform the optimization further based on at least one additional loan as suggested by the processor using the DOE algorithm, and the optimization engine uses asset balances to adjust loan amounts of the additional loan such that the loan balances of the existing loans are restructured, eliminated, or consolidated. In some examples, the optimization engine is configured to perform the optimization with constraints applied to limit monthly payment.

In some examples, the optimizer engine may include parameters that influence rate by parameters considered outside of the debt portfolio. For example, “relationship pricing” refers to discounts on loan rates that are associated with a customer's engagement with a bank or lender. Discounts on borrowing rates can be available by setting up a direct deposit or moving money from an account into an account within the bank or lender's institution. The optimizer engine may assess asset transfer, direct deposit options, or other parameters not directly associated with the loan as an optional degree of freedom in the multi-dimensional optimization. For example, if a bank was offering a 0.25% discount to transfer 10% of the primary loan amount into an institution's management, the optimizer engine could optimize the loan amount to enable this transfer threshold was achievable with the customer's existing asset amounts. This process could be done continually and triggered on changes to the relationship pricing parameters, asset account balances, or loan amounts that change over time.

In some examples, the optimization may include merit-function optimization which can contain one or many factors used in its evaluation. In some examples, the merit function used in the optimization engine minimizes the total interest and origination cost of an individual loan. In some examples, the merit function used in the optimization engine minimizes the sum of the interest costs and refinancing fees for multiple loans in the loan portfolio. In some examples, the merit function used in the optimization engine minimizes the sum of the interest costs and refinancing fees for a new loan together with a restructuring or consolidation of multiple existing loans in the loan portfolio. In some examples, the merit function used in the optimization engine includes the savings associated with a specific loan's tax deductible loan interest. In some examples, the merit function used in the optimization engine includes the investment earnings and opportunity cost of money that is paid to reduce overall borrowed amount. In some examples, the merit function includes the time-value of money or inflation as an influence on total portfolio cost. In some examples, the merit function used in the optimization engine is assessed for the lifetime of all loans. In some examples, the merit function used in the optimization engine over a time period less than the longest loan in the portfolio, for example ten years. In some examples, the merit function used in the optimization engine includes constraints on calculated parameters such as the total monthly payment of all loans being considered or the maximum amount of money to be transferred from an asset into a loan (e.g., cash to close).

In some examples, the rate quotes are associated with a plurality of lenders in a lender space. The optimization is configured to: calculate a plurality of local optima based on the plurality of rate quotes; and based on the local optima as calculated, select a single global optimum using the user data as constraints, to be displayed as the optimized result. In some examples, each of the local optima is a point of pareto optimality calculated by the optimizer engine. In some examples, each local optimum of the plurality of local optima represents the optimized result for one lender from the plurality of lenders. In some examples, the optimized result includes one or more of: an optimal amount of down payment, an optimal amount to borrow, or an optimal length of time to repay the amount borrowed. In some examples, calculations for the optimization are performed at or near real-time. In some examples, the one or more processors are configured to continuously obtain and update the plurality of rate quotes at a time interval from 1 minute to 30 minutes.

According to some embodiments, non-transitory computer-readable storage media are disclosed. The non-transitory computer-readable storage medium stores instructions which, when executed by one or more processors, causes the processors to: acquire a user data profile associated with a user, wherein the user data profile includes income, credit score, assets, and a debt portfolio including existing liabilities held by the user; obtain a plurality of rate quotes in response to acquiring the user data profile; activate an optimizer engine to perform optimization to obtain an optimized result based on the user data profile and the rate quotes; and notify, on a user interface of a user device, the user of the optimized result, wherein the optimized result includes an optimum loan product or an optimum loan portfolio as determined by the optimizer engine.

In some examples, the rate quotes are associated with a plurality of lenders in a lender space, and the optimization is configured to: calculate a plurality of local optima based on the plurality of rate quotes; and based on the local optima as calculated, select a single global optimum using the user data as constraints, to be displayed as the optimized result. In some examples, each of the local optima is a point of pareto optimality calculated by the optimizer engine. In some examples, each local optimum of the plurality of local optima represents the optimized result for one lender from the plurality of lenders. In some examples, the optimized result further includes one or more of: an optimal amount of down payment, an optimal amount to borrow, or an optimal length of time to repay the amount borrowed. In some examples, calculations for the optimization is performed at or near real-time. In some examples, the lender space comprises at least 100 lenders each offering a plurality of different loan products. In some examples, the one or more processors are configured to continuously obtain and update the plurality of rate quotes at a time interval from 1 minute to 30 minutes.

According to some embodiments, computing systems are disclosed. The computing system includes: a user device having a user interface associated with a user; one or more processors operatively coupled with the user interface; and a memory operatively coupled with the one or more processors. The memory stores instructions which, when executed by the one or more processors, causes the processors to: acquire a user data profile associated with the user, wherein the user data profile includes income, credit score, assets, and a debt portfolio including existing liabilities held by the user; obtain a plurality of rate quotes in response to acquiring the user data profile; activate an optimizer engine to perform optimization to obtain an optimized result based on the user data profile and the rate quotes; and notify, on the user interface of the user device, the user of the optimized result, wherein the optimized result includes an optimum loan product or an optimum loan portfolio as determined by the optimizer engine.

It should be appreciated that in various embodiments the foregoing concepts, and additional concepts discussed below, may be arranged in any suitable combination. Further, other advantages and novel features of the present disclosure will become apparent from the following detailed description of various non-limiting embodiments when considered in conjunction with the accompanying figures.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a block diagram of a network system incorporating therein a client device or a remote device capable of accessing the loan product quotes from the various loan provider systems, in accordance with embodiments of the present disclosure;

FIG. 2A is a graph of loan amount and annual percentage rate (APR) showing a borrower's feasible range and a single-variable optimization performed on the loan amount in view of a lender's APR curve to change the borrower's APR, in accordance with embodiments of the present disclosure;

FIG. 2B is a graph of loan amount and annual percentage rate (APR) showing a borrower's feasible range and a single-variable optimization performed on the loan amount in view of two different lender's APR curves to change the borrower's APR, in accordance with embodiments of the present disclosure;

FIG. 3 is a graph comparing the results of an exemplary nonlinear, multi-variable, constrained optimization for multiple lenders, in accordance with embodiments of the present disclosure;

FIGS. 4A and 4B are block diagrams for performing a process of loan product comparison and optimization, in accordance with embodiments of the present disclosure;

FIGS. 5A through 5C are graphs used for merit function calculation where the APR is shown as a function of loan-to-value, FICO score, and loan amount, where the user-specified lowest APR is the objective for optimization, in accordance with embodiments of the present disclosure;

FIGS. 6A and 6B are graphs used for merit function calculation where compound annual growth rates (CAGR) are taken into consideration in view of APR and down payment as well as a net-worth after 20 years, in accordance with embodiments of the present disclosure;

FIG. 7 is a flow diagram implementing a merit function optimization algorithm to determine a global optimum, in accordance with embodiments of the present disclosure;

FIG. 8 is a flow diagram of a method or process implemented in accordance with embodiments of the present disclosure;

FIG. 9 shows examples of rate sheets showing the base rates and rate modifiers;

FIGS. 10A through 10C are graphs comparing the points and fees to the APR of different loan products offered by different lenders for different loan amounts and LTV values; and

FIGS. 11A and 11B are examples of information and graphs which may be displayed for the user's review in accordance with embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, when an element, component, device or layer is described as being “on” “connected to,” “coupled to” or “in contact with” another element, component, device or layer, it can be directly on, directly connected to, directly coupled with, in direct contact with, or intervening elements, components, devices or layers may be on, connected, coupled or in contact with the particular element, component or layer, for example. When an element, component, device or layer for example is referred to as being “directly on,” “directly connected to,” “directly coupled to,” or “directly in contact with” another element, component, device or layer, there are no intervening elements, components, devices or layers for example.

Although illustrative methods may be represented by one or more drawings (e.g., flow diagrams, communication flows, etc.), the drawings should not be interpreted as implying any requirement of, or specific order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” “series” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a specific piece of information may additionally, or alternatively, base the same determination on another piece of information.

Most borrowers and many brokers are unaware that there is a continuum of ways to apply for a particular loan by adjusting application parameters that the borrower can be flexible on. This can deliver favorable effects on the total cost of debt by one or more of: (1) achieving a lower borrowing rate, (2) lowering their costs at close for a given rate, and/or (3) allowing the borrower to become eligible for products that were otherwise filtered out of the search if just the singular ‘baseline’ case was assessed. The mechanics behind the rate-adjustments (APR-adjustment), price-adjustments (cost-to-close adder), and product-eligibility are unique per loan product and depend on many factors including but not limited to the total loan amount, property value, points & credits, duration of rate lock, credit score (FICO), cash balances, and other obligatory debt payments such as student loan payments or auto loan payments. These impact both the rate and eligibility of a borrower across thousands different of loan products.

Further, many parameters are interlinked. For example, the selection of the points and credits influences the rate, and hence the monthly payment as well as the cash reserve level. A higher rate results in a higher monthly payment and may mean maximum debt-to-income constrains cannot be met with other obligatory debt, rendering that loan product inaccessible. Without an optimization engine running to adjust loan amount, FICO, lock duration, points and credits, or what can be done with other debt payments holistically, the best-priced option for the borrower may go unseen, resulting in a higher cost of debt to the borrower.

There are hundreds of lenders and thousands of loan products, each with their own eligibility constraints, fees, rates, rate modifiers, and price modifiers. It is patently unreasonable for a borrower or broker to call each one to obtain individual quotes when an interaction may consume 30 minutes to 1 hour. Additionally, obtaining quotes regularly requires hard credit pulls, each of which lowers the borrower's credit score and therefore preventing continual “shopping around.” On the broker side, even with the best mortgage banker or broker using the best existing loan filter software tools, it is patently impossible to identify the optimal loan product using manual adjustments of the several available terms in the available time between loan product pricing updates. Algorithmic optimization is required to identify the combination of the best product and the method to apply.

For optimization to work, a model of the goal must be made, which requires a way to replicate the rate that a lender would otherwise quote in order to conduct subsequent mathematical calculations on the goal of the optimization (e.g., minimize the borrower's total cost of debt). Several methods exist here, including machine learning, artificial intelligence (AI), and many numerical methods of fitting a large volume of quotes against input conditions. One alternative to a predictive model is to use the deploy the same direct mathematical calculations that the lenders use. Most lenders compute the final rate starting with a base rate, reflective of the general financial markets, and adding to it a series of positive or negative rate-adjusters (adders to the APR). Such rate adjusters often tabulated in discretely binned levels, producing a stair-step type of influence on rates. Additionally, some of these tiered levels are based on multiple parameters (e.g., 2D table) wherein there are interlinked combinations of the inputs that influence the final rate adjustment. For example, a rate adjustment table may have one input of credit score (FICO) and one of loan-to-value ratio (LW), or loan amount vs FICO score. These rate modifiers may also be influenced by other aspects such as property type (primary residence, second home, investment property, etc.), mortgage vehicle type (e.g., 30-year fixed, 5/1 adjustable rate, etc.), loan type (e.g., refinance, cash-out refinance, first purchase, etc.). In addition to rate-adjusters, there are “price modifiers” which modify the points and credits amount. This is a fee (paid by borrower to lender) or credit (paid by lender to borrower), typically represented as a percent of the loan amount due at close, and the adjustment that enables rates to stay at even ⅛^{th} intervals (e.g., 3.125%, 3.250%, 3.375%, etc.). Points and credits are influenced by factors such as rate-lock duration, or broker fees, or loan amount. These also allow the user to pay a fixed sum at close to access a lower-than-market rate or to take cash back from the lender at close and pay a higher-than-market rate. The amount of points and credits chosen influences borrowers' cost to close, final rate, monthly payment, and hence debt-to-income and cash reserve qualifying criteria.

If the mortgage officer were to adjust the input parameters such as loan amount (or down payment), LTV ratio, and the FICO score, a lower total interest cost may be realized. However, each lender may have its own unique rate modifiers and price modifiers axes (bins or tiered levels), qualifying thresholds, and modifier values, so applying the same change in input parameters will not influence the final rate in a similar amount across all lenders. Hence, in order for mortgage officers or borrowers to truly “shop around” different offers from different lenders, they would need to sweep all parameters for each product/lender while ensuring the application remained within the constraints of each individual product, which is patently unreasonable to expect anyone to do. Hence, brokers use an application programming interface (API) on the lender's interface to produce a single rate quote based on a single instance of the borrower's input parameters. They also rely on filters to eliminate from view the products that the borrower appears to be ineligible for based on the inputs.

While solutions exist (or are actively in development) to streamline the final loan origination process (e.g., DocuSign®, posting documents online for income verification, digital notaries, etc.), the lending industry lacks financial motivation to actively and continually scan the full lending market, optimize the way a borrower applies for the loan, and to structure the fees to the advantage of the borrower because it reduces the margins and revenue of the many businesses in the space.

All other debt obligations the borrower has, such as student, vehicle, credit card debt, other mortgages, etc., also face a similar weakness wherein optimization of how the application is constructed can advantage those individual rates. The same processes described can be applied to these secured or unsecured debt products for a goal of extracting the lowest rate, albeit with different adjustment factors. Further, co-optimization of this debt together provides flexibility to reducing the individual rates of one or both products. This is referred to as a debt portfolio optimization, but generally means that one debt product is manipulated to advantage another. This can be done all-at-once, meaning all refinances are redone together, or in a serial fashion wherein one or more steps in debt restructuring are taken in order to advantage the overall debt costs. For example: a mortgage optimization may identify a product that has the lowest rate, but is inaccessible because of a debt-to-income threshold not being met by an amount of, for example, $300 per month. This borrower holds an 8-year student loan debt with a monthly payment of $400 but has no cash reserves or home equity with which to pay it off. The user could refinance the student debt to a longer duration (e.g., 20 years) which lowers the payment to, for example, $100 per month, subsequently qualifying the user for the lowest rate mortgage product. After closing the mortgage loan, the user's monthly payment obligation is reduced, which then enables the student loan to be re-refinanced back to a shorter duration, thus leveraging debt co-optimization to significantly lower the overall borrowing cost.

Lenders are not motivated to continually repeat the manual optimization process to continually watch for opportunities for their clients to lower their rates because lower rates reduce the lenders' margins. As such, the burden falls to the borrower to manually interact with mortgage bankers and brokers for quotes which takes time and credit score implications. Bait-and-switch APR advertising, credit score hits, and the high effort to get each rate quote can often be futile, demoralizing, inefficient, and lead borrowers to set-and-forget their loans. Providing a live market monitor that does not require credit score polling enables borrowers to continually ratchet down their borrowing rates as soon as one becomes available.

Further, there are known influences for FICO score such as credit history, payment history, credit usage percent, etc. Tools are available to predict credit score impacts for changes to the above, but they are not utilized in a coupled-method to quoting loan products. For example, a borrower with a credit score of 682 currently is carrying credit card balances that result in a credit utilization of 40%. It is known that a lower credit utilization tends to improve credit score. However, from correlated models of FICO scores and the influencing parameters, the relationship between how much balance is paid down and the impact (increase) to FICO score is known. Because paying off revolving debt in its entirety will reduce cash reserves, a borrower may be disqualified from the best product even if credit score is increased the maximum. As such, there is an ideal amount in which to pay off some of the revolving debt that improves the credit score into the next “bin” and still leaves sufficient cash reserve to qualify for the best product. Hence, holistic optimization of FICO score models and the loan application parameters is needed to minimize the cost of debt.

To properly and continually scan the lending market, it is important that the borrowers' information is also live (up-to-date). Importing live borrower data through a banking data portal or similar method to extract basic account balance information (brokerage, retirement, savings, etc.) will provide a key live view of cash reserves (a key eligibility filter) to be available in the market scan. Further, coupling with banking or other systems that can deliver gross income level live can keep track of changing income levels. Additionally, property robot-appraisals (e.g., Zestimate) together with live interest rate pricing can be used to find the property value—a direct influencer on loan-to-value and rates. Combining live information from the borrower (e.g., income, account balances) and property information, such as value, gives the ability to identify when new product become eligible from both ends of the market (borrower side and lender side).

From trajectories identified in the market on debt pricing combined with the financial state of the borrower, a timeline and goal set can be provided to target the ‘next’ opportunity to lower borrowers' costs. Whether it is a FICO score goal, or cash savings account goal, or income, property value, or loan balance, delivering a target for the borrower lets them work on financially engineered metrics to lowering their cost of debt. This can be done on all debt products, and smart management of excess payments. For instance, if a borrower had $5000 remaining on student debt and payments were $500 per month, excess payments to that account (even if it was not the highest APR debt) would, once paid off, expose products with debt-to-income filters that were not possible with the prior student debt payment obligation. Hence holistically strategizing the debt payoff sequence of events with full market knowledge coupled in is important to minimizing borrowers' overall debt cost.

Nuanced and non-transparent fees are costing borrowers billions. Each mortgage agent, broker, or banker has the ability to hide their renumeration in the points and credits from borrowers using a “lender-compensated” billing model. This poses two problems. First, borrowers are unaware how much their loan agent has made, which can result in very high fees (1-2% of the borrowed amount on each finance). Second, these lender-paid fees are paid on the back end from the lender (money provider) to the broker/agent. These lender-paid fees are not disclosed to the borrower and are the present-day value of the borrower having locked a rate well-above the market. A 2% lender-compensated fee drives up the APR by approximately 0.5%, which results in the total interest cost on the loan going up by approximately 10% of the loan, all while the borrower thinks he or she is getting “market rates” in the quote. The solution to this is to structure the renumeration in how much the agent can save the borrower with respect to a reference point. A profit-sharing or debt-savings-sharing revenue business model is important in order to align business revenue with whatever-it-takes to deliver the lowest possible cost of debt to borrowers.

As such, there is a strong need for an improved process to (1) scan the full lending market with live borrower data, (2) globally and holistically optimize the loan product applications and (3) structure the fees to advantage the borrower's goals.

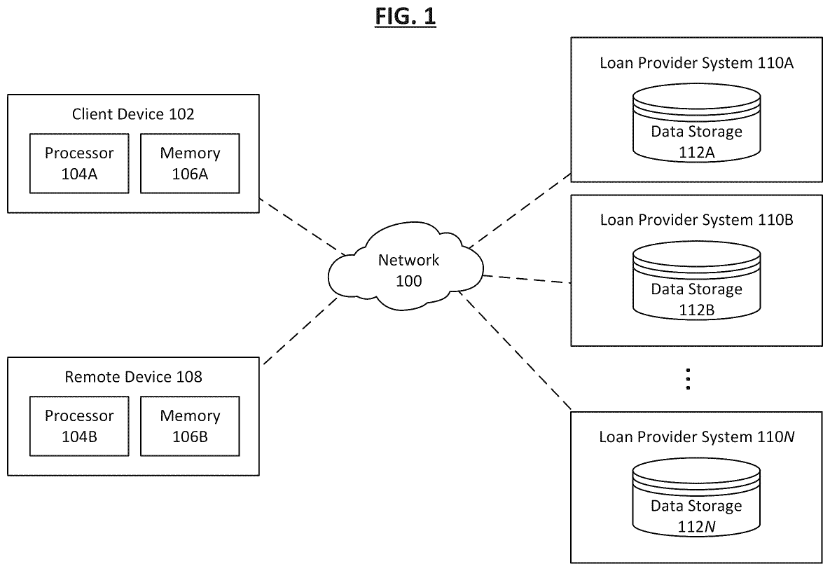

FIG. 1 depicts an illustrative diagram of a network system 100 which interconnects a client device 102, a remote device 108, and a plurality of loan provider systems 110. The devices 102 and 108 each includes a processor 104 and a memory unit 106 and may be referred to as a computing device or computing system. The memory unit 106 may be one or more computer-readable media in the form of volatile and/or nonvolatile memory, transitory and/or non-transitory storage media and may be removable, nonremovable, or a combination thereof. For example, the memory unit 106 may be a non-transitory computer-readable storage medium storing instructions which, when executed by one or more processors (such as the processor 104), causes the processors to perform a method or process as disclosed herein, for example the method or process 400 and/or 800. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some embodiments, the one or more memories store computer executable instructions for causing one or more processors 104 to implement aspects of embodiments of system components discussed herein and/or to perform aspects of embodiments of methods and procedures discussed herein.

Computer-executable instructions may include, for example, computer code, machine-useable instructions, and the like such as, for example, program components capable of being executed by one or more processors 104 associated with a computing device. Program components may be programmed using any number of different programming environments, including various languages, development kits, frameworks, and/or the like. Some or all of the functionality contemplated herein may also, or alternatively, be implemented in hardware and/or firmware.

The one or more processors 104 may be configured to execute the computer executable instructions to perform certain operations. They are not intended to suggest any limitation as to the scope of use or functionality of embodiments of the present disclosure. Neither should they be interpreted as having any dependency or requirement related to any single component or combination of components illustrated therein. Additionally, various components depicted in FIG. 1 may be, in embodiments, integrated with various ones of the other components depicted therein (and/or components not illustrated), all of which are considered to be within the ambit of the subject matter disclosed herein.

The loan provider system 110 each includes a data storage 112 which may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data storage 112 may be, for example, a single relational database. In some cases, the data storage 112 may include a plurality of databases that can exchange and aggregate data by data integration process or software application. In an exemplary embodiment, at least part of the data storage 112 may be hosted in a cloud data center. In some cases, a data storage 112 may be hosted on a single computer, a server, a storage device, a cloud server, or the like. In some other cases, a data storage 112 may be hosted on a series of networked computers, servers, or devices. In some cases, a data storage 112 may be hosted on tiers of data storage devices including local, regional, and central.

The network system 100 may implement communication interfaces including but not limited to local area network (LAN), Bluetooth™ standard, IEEE 802 standards, wide area network (WAN), cellular network interfaces, satellite communication interfaces, or other public or proprietary wireless protocols as suitable. The communication interface may be either within a private computer network, such as an Intranet, or on a public computer network, such as the Internet. The communication interface may implement wired or wireless communications.

It is to be understood that the algorithms, methods, and processes as disclosed herein can be performed by either the processor 104A of the client device 102 or the processor 104B of the remote device 108, as suitable. For example, if the client device 102 is not deemed to have the sufficient calculational capability (e.g., if it is a mobile device such as a smartphone), the remote device 108 that is operatively coupled with the client device 102 via the network 100 such as via a cloud network may be used to receive inputs and parameters from the client device 102 and perform the necessary calculation based on the provided inputs and parameters, and subsequently transmit the results to the client device 102 for the client's review. It is to be understood that a plurality of remote devices 108 may be utilized to perform different calculations or processes in real-time and/or simultaneously to save time, after which the results can be displayed for the client's review via a user interface of the client device 102, for example.

The client device 102 and/or the remote device 108, which shall be collectively referred to herein as a “computing device” regardless of whether there is a single device or a plurality of devices working together, is capable of sending data to each of the loan provider systems 110 (A, B, . . . , and N, as shown) and obtain quotes (or, as explained herein, new or updated rate sheets) in return. Each system 110 may represent a different lender or financial institution. Each system 110 may also be a quote aggregator itself, which has collected and compiled quotes from one or more other lenders, financial institutions, or aggregators. Based on the numerous quote results provided by the loan provider systems 110, the computing device chooses the quote result (or a plurality of quote results) which would best fit the needs and conditions of the client using methods, processes, or algorithms as disclosed herein.

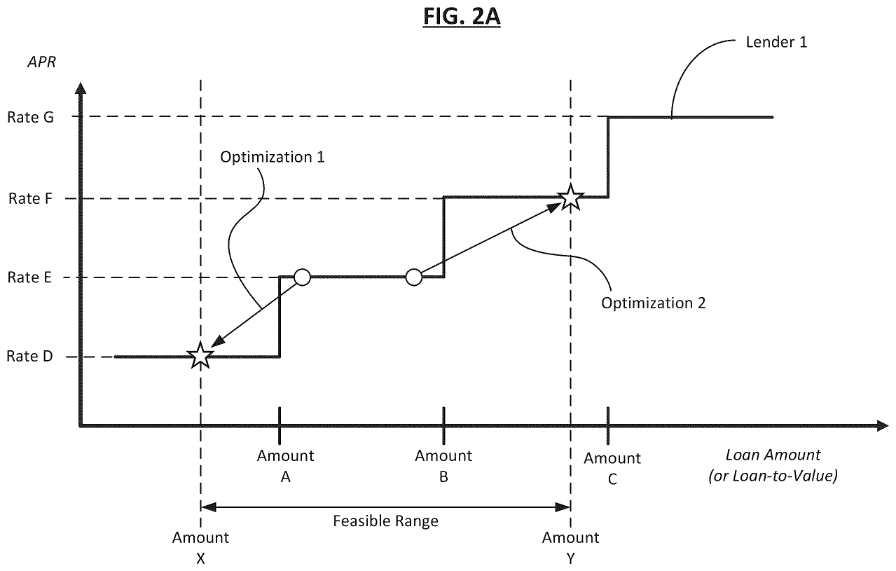

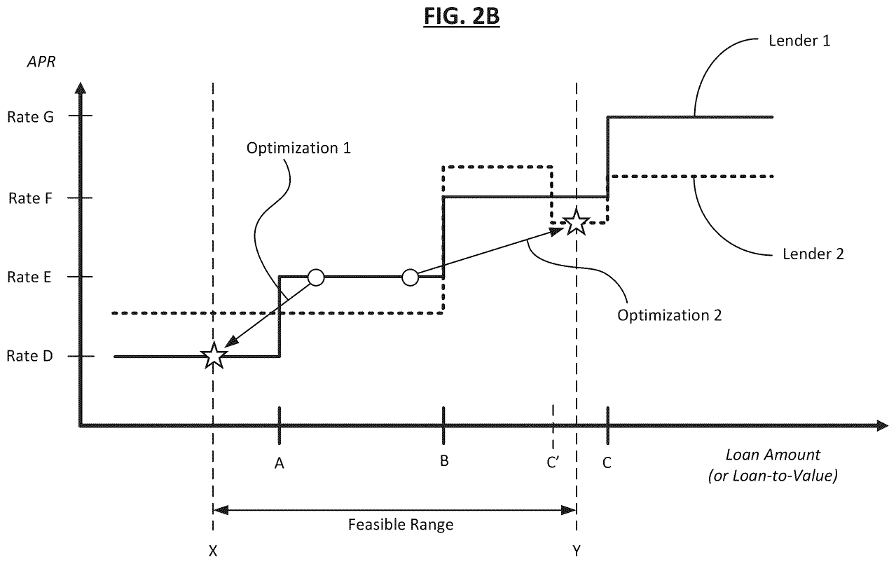

FIG. 2A illustrates a single-lender single-variable example of how a constrained optimization may be performed by the computing device according to some embodiments. The graph shown in the figure indicates the loan amount, or LW amount that the borrower can choose to take out, with the borrower choosing a feasible range of loan that can be taken out, the lower threshold being Amount X and the upper threshold being Amount Y. Typically, the lower threshold is determined by a cash reserve limit of the borrower, and the upper threshold is determined by a debt-to-income limit of the borrower. An annual percentage rate (APR) curve is shown for a single lender (“Lender 1”) where the APR value increases not proportionally with the loan amount but incrementally. For example, when a loan of less than Amount A is taken out, the APR is at Rate D, but upon reaching Amount A, the APR increases to Rate E. When the loan amount reaches Amount B, the APR further increases to Rate F, and at or above the loan amount of Amount C, the APR further increases to Rate G.

The only variable in this example is the amount of loan that is to be taken out, so optimization can be performed by adjusting the loan amount. For example, in “Optimization 1,” as the loan amount decreases to Amount X (from “circle” to “star”), it achieves the lowest APR and lowest monthly payment, whereas in “Optimization 2,” as the loan amount increases to Amount Y, it achieves the largest loan amount being taken out and also the most leverage. The borrower can choose between the two optimized loan amounts to take out from Lender 1, based on which “goal” is to be achieved for the specific situation of the borrower.

FIG. 2B illustrates a multiple-lender (two in this example) single-variable (APR vs LW) example of how a constrained optimization may be performed by the computing device according to some embodiments. In addition to the APR curve of Lender 1, an APR curve for another lender (“Lender 2”) is shown where the APR value stays flat at a value, such as between Rate D and Rate E, below a certain LTV value, such as below Amount B. However, instead of increasing incrementally with the increase in loan amount as did the APR of Lender 1, the APR of Lender 2 decreases at a certain point. For example, the APR of Lender 2 increases to between Rate F and Rate G upon reaching Amount B, which is a greater increase than Lender 1, but when more is borrowed, for example past Amount C′, the APR decreases to between Rate E and Rate F, and upon reaching Amount C, the APR increases to between Rate F and Rate G, which is less than the APR of Lender 1 for the same LW range.

In this example, Optimization 1 would remain the same as in FIG. 2A; that is, it would be beneficial to borrow Amount X from Lender 1 to achieve the lowest APR and lowest monthly payment. However, Optimization 2 would be different in that it would be more beneficial to borrow Amount Y from Lender 2 than from Lender 1, because Lender 2 offers a lower APR than Lender 1 at Amount Y. Therefore, different objectives or goals of the borrower may cause the optimization to suggest borrowing from different lenders when multiple lenders are available to provide the loan. This is referred to as “shopping around” for the optimum loan product that suits the needs and goals of the borrower.

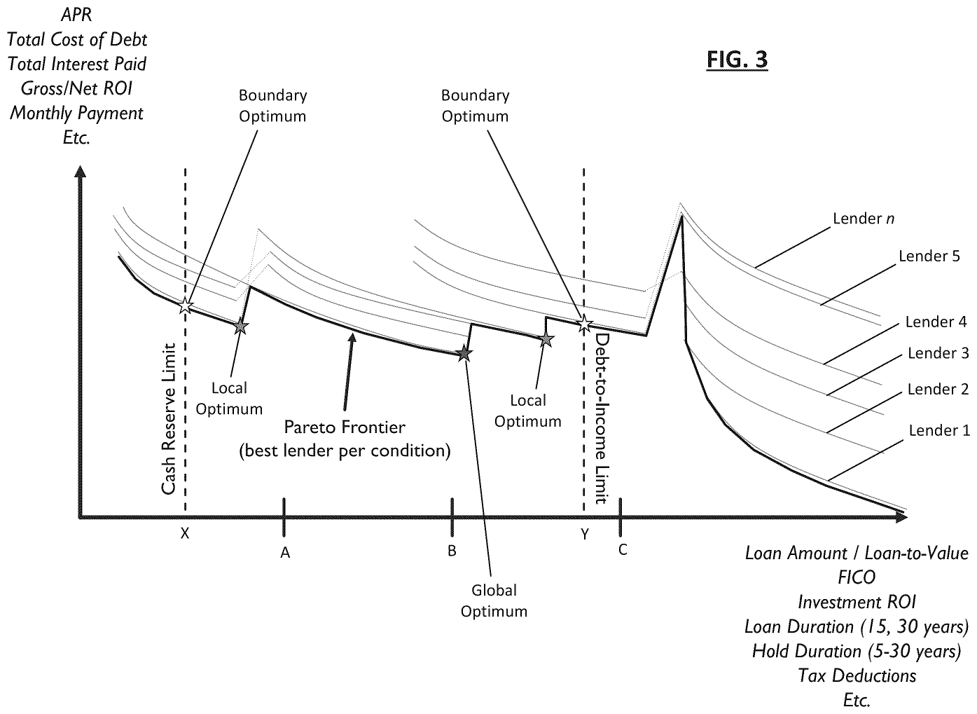

FIG. 3 illustrates a more complex, multiple-lender multiple-variable example of how an optimization may be performed by the computing device according to some embodiments. The optimization in this example may be nonlinear, multi-variable (multi-objective), and constrained. Instead of only the LTV amount being the variable input (the x-axis), there may be other inputs such as FICO score, return-on-investment (ROI), loan duration, hold duration, tax deductions, etc. Furthermore, there may be multiple outputs (the y-axis) as well, such as the APR, the total cost of debt, total interest paid, gross/net ROI, monthly payment, etc.

Each lender has a unique curve as shown by Lender 1, Lender 2, Lender 3, etc., up to Lender n of any suitable number. Each curve may be calculated based on any number of inputs (borrower's parameters or conditions) and outputs (lender's parameters or conditions with which the loan can be taken out by the borrower), and each of the multiple inputs and outputs may be weighted differently during optimization based on the needs or goals of the borrower. “Boundary Optimum” shows the optimum lender to borrow from when the boundary loan amount (Amount X or Amount Y) is to be selected at the minimum or maximum threshold. “Local Optimum” is the combination of both the optimum input value and the optimum lender to borrow from, based on any detected “dip” or “valley” in the curve as shown. For example, the dip may be caused an increase in the output of a first lender's curve (for example, an increase in the APR, total cost of debt, total interest paid, etc.) when the input is increased, in which case the local optimum may be determined to be the point immediately preceding such increase. The curve (shown as a bold line in FIG. 3) connecting all the local optima is referred to as a “pareto frontier” of a high-order multi-objective optimization defining the best lender for each input value along the x-axis, and each local optimum may be considered as a point of pareto optimality.

When a plurality of local optima are calculated, one local optimum may be selected as the “Global Optimum” with the absolute (optimized to the goals of the borrower) lowest output (available rate offered by any lender on the market) throughout the entire feasible range between X and Y. This global optimum would be the recommended condition at which the borrower should be taking out the loan, which indicates the optimal input values to provide to the appropriate lender who is optimal to borrow from at the provided input values.

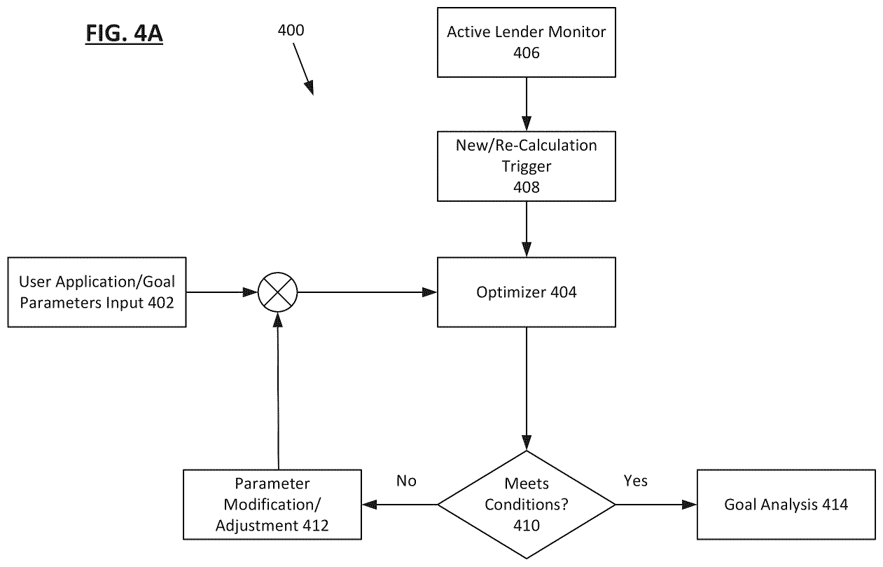

FIG. 4A shows a high-level flow diagram of a method or process 400 (which may be computer-implemented as a computer algorithm using appropriate software and hardware) implemented to perform the appropriate optimization of loan products and loan application. The blocks as illustrated may be performed using a processor or a plurality of processors (for example using cloud computing capability as known in the art), and each block may represent a step or a series of steps necessary to perform certain functions as disclosed herein.

In block 402, user application and goal parameters are inputted into the computing device. For example, the user may input parameters such as: a desired loan amount, how much the user can provide as down payment (cash reserve or savings) if applying for a mortgage, the user's income, an intended loan duration, FICO score, etc. In some examples, the user input parameters may be any one or more of the following: income, assets, debts, tax bracket, expected/target duration to hold loan/property, expected/target return-on-investments and savings, expected/target property appreciation, expected/target rental income (if the property is rental), and/or days-to-close, as well as the flexibility and range option on all the input parameters as provided and the user's objective(s), which may be one or more of: maximum net worth after a user-defined number of years, minimum monthly payment, minimum APR, minimum tax, minimum interest paid, and/or tradeoff/pareto optimality of multiple objectives. The lender may also have input parameters, which may include one or more of: base rate vs points/credits and/or rate and points/credits modifiers which may include one or more of: FICO score, new loan vs refinancing, loan amount, LTV ratio, property type, property intensions (e.g., investment, rental, second home, etc.), and/or days-to-close.

In block 406, the lenders are actively monitored by the computing device such that whenever new or updated rate sheet(s) is/are provided by any one or more of the multiple lenders who are being monitored, the new or updated rate sheet(s) would be fetched or imported and then implemented in the optimization calculation. In response to detecting that the new/updated rate sheets are provided, in block 408, a new calculation or a recalculation is triggered based on the provided rate sheets.

In block 404, an optimizer function takes into consideration both the user inputs and parameters from block 402 and the rate sheets provided from block 406 in order to determine a global optimum that may be suitable for the user as determined based on different constraints that are evaluated, as further explained herein. It is to be understood that the optimization calculations may be performed at or near real-time, that is, within a few seconds or minutes after the rate sheets are provided (e.g., less than about 15 seconds, less than about 30 seconds, less than about 1 minute, less than about 3 minutes, less than about 5 minutes, less than about 7 minutes, less than about 10 minutes, less than about 15 minutes, less than about 30 minutes, or any other value or range of time therebetween), in order to avoid these rate sheets “expiring” when further new/updated rate sheets are generated by the lenders, thereby making the provided rate sheets obsolete.

In block 410, the computing device determines if the global optimum determined by the optimization block 404 meets the conditions or constraints as set by the user. If these conditions or constraints are not met, the computing device proceeds to block 412 in which slight modifications or adjustments are applied to the input parameters in order to uncover other solutions that may be feasible to meet the conditions/constraints of the user. The computing device may vary the available application parameters (input parameters) within tolerances (limits) that the user is able to adjust, which includes, but are not limited to, loan amount, points/credits, rate lock duration, etc. The adjustments enable some products to become available which would not have before, as well as to identify when and how to apply for the loan so as to minimize the total cost of the user to service the debt. Such modifications/adjustments must be within the initial range of parameters as provided by the user, but if further modifications/adjustments that are beyond the user-provided range are necessary, such indication may be presented to the user at this stage.

In some such examples, the notification may include a suggestion for the user to take out a secondary loan separately in order to increase the user's cash reserve and therefore increase the down payment for the primary loan (which is greater than the amount of the secondary loan). Doing so will incur interest on the secondary loan, but the additional down payment for the primary loan would drop the LTV ratio to a lower bin or tier on the rate sheet (for example, impacting a drop of several tenths of a percentage point in the APR) which would in turn lower the total interest cost of the primary loan, possibly saving the user thousands of dollars as compared to when no secondary loan was taken out, even when considering the interest paid on the secondary loan.

In some examples, a notification in this regard may be sent to a liquidity provider to enable refinances or loan repositioning of the user in view of the benefits that can be generated in doing so, thereby requesting the liquidity provider to serve as an interim capital investor or fiduciary on behalf of the user, for example in case the user cannot afford the cost of refinancing that would otherwise enable the user to access a lower tier of APR, among others. The liquidity provider can provide liquidity in the form of a loan (secondary loan) for which the payback for the liquidity provider is a percentage of the amount of money that the user would be able to save in the process. This would beneficially expand the options available to the user and enable refinancing of loan products and loan vehicles that have lower borrowing rates for users who may not be able to pay for the lower APR tier up front.

As an illustrative example, because the LTV ratio is a factor that strongly affects the APR value, if the user can buy down the loan with a payment to lower the loan amount, the LW would drop, and the APR would also drop significantly (for example, an impact of several tenths of a percentage point in APR). If an additional $10,000 into the loan amount could affect the LTV such that the quoted APR would be reduced by 0.25%, but the user does not have the available cash reserves to do so, the aforementioned liquidity provider may be able to provide the necessary $10,000 to the user in the form of a loan and recoup the investment with the user paying the liquidity provider back at 75% of the savings afforded by the 0.25%-drop in APR, for example. Once repaid, the user retains the lower APR for the life of the loan. Monthly repayment may be designed to ensure that the lending vehicle of interest does not get removed with the higher monthly payment obligation.

If, in block 410, the computing device determines that the global optimum determined by the optimization block 404 meets the conditions or constraints as set by the user, the computing device may proceed to block 414 in which it is determined whether the user's goals are met. In some cases, even after applying modifications to the parameters, the user may not be able to meet the goals as initially set. If so, the user may wait for changes in the market. If block 414 determines that the user's goals are met, the user may be alerted via notification such as an email, phone call, or push alert on the smartphone in order to initiate the loan application process at the global optimum condition with the determined lender before the lender's rate sheet expires.

FIG. 4B shows an example of a more detailed block diagram of the method or process 400 as summarized in FIG. 4A, according to some embodiments. For example, the active lender monitor block 406 may include a plurality of monitoring sub-blocks, each for a different lender, such that hundreds or thousands of lenders (for example, at least 100 lenders, at least 500 lenders, at least 1000 lenders, at least 1500 lenders, at least 2000 lenders, at least 2500 lenders, at least 3000 lenders, at least 4000 lenders, at least 5000 lenders, or any other suitable value or range therebetween) can be monitored constantly, continuously, and simultaneously, where each lender may provide a plurality of loan products. For example, the “check/query” block shows that the computing device is in constant communication with the specified lender (e.g., one of the data storages 112 of the loan provider systems 110) by constantly (i.e., at or near the limits of transmission via a network) checking or sending queries for new or updated rate sheets from the lender. In the “new rate sheet?” block, the computing device determines whether a new rate sheet is provided by the lender, and if there is none (“no”) the computing device waits for a predetermined amount of time, such as n seconds (in “wait n sec” block) before returning to the “check/query” block to check again. The amount of time may be, for example, from 1 second to 10 seconds, from 10 seconds to 20 seconds, from 20 seconds to 30 seconds, from 30 seconds to 60 seconds, from 1 minute to 2 minutes, from 2 minutes to 5 minutes, from 5 minutes to 10 minutes, from 10 minutes to minutes, from 15 minutes to 30 minutes, or any other value or range therebetween.

If the computing device detects a new rate sheet (“yes”) the computing device proceeds to automatically fetch or import the new rate sheet (the “fetch/import” block) and scan the new rate sheet for number values to import as raw rate parameters and fees such as points/credits for a plurality of loan products from the designated lender (the “scan” block). The loan products may include, but are not limited to, 30-year fixed loans, 20-year fixed loans, 15-year fixed loans, 5/1 ARM loans, interest-only options, etc., for a plurality of loan programs including, but are not limited to, jumbo loans, conforming loans, retail loans, etc.

The computing device then parses the imported raw rate parameters into functions (the “parse into functions” block) for use by the optimizer block 404. For example, the computing device may parse the lender rate quote information in such a way that the computing device can virtually quote an APR and fee structure for the user directly, as well as to identify if and how far out of bounds the user is to qualify for the specific loan vehicle for which the user is intending to apply. The optimizer block 404 then receives the input parameters from the user as obtained in block 402 as well as the parsed data from the block 406 and performs the optimization based on the data. According to some examples, the optimizer block 404 may include any one or more of a plurality of different optimization methods as indicated below.

For example, in the “method 1” block, the computing device may apply a designed experiment via a design of experiments (DOE) algorithm using degrees of freedom (DOF) determined by various factors/parameters which may affect the rate quotes, and/or model fitting in which, during the fitting process, an algorithm is run on data for which the target variable is known and produce a machine learning model, and then the outcomes are compared to real, observed values of the target variable to determine their accuracy, as known in the art.

For example, in the “method 2” block, the computing device may perform gradient descent, which is an iterative first-order optimization algorithm used to find a local minimum/maximum of a given function. This method is commonly used in machine learning (ML) and deep learning (DL) to minimize a cost/loss function (e.g., in a linear regression), as known in the art. In some examples, the computing device implements a multi-start strategy in which multiple instances of a local search algorithm are started, and computational resources (processing time) can be allocated to the instances depending on their behavior, thereby avoiding the optimization process to be trapped in a local optimum, as known in the art.

For example, in the “method 3” block, the computing device may create a genetic algorithm which is a search-based optimization technique based on the principles of genetics and natural selection in order to find the local optima and the global optimum, as known in the art.

For example, in the “method 4” block, the computing device may generate a particle swarm algorithm, which is a heuristic approach to determining local optima that can then be collectively analyzed to determine the global optimum, as known in the art.

For example, in the “method n” block, the computing device may generate any other suitable “global optimization” strategy as known in the art, in order to determine the global optimum point for the user. Such methods may be driven by artificial intelligence, machine learning, deep learning, etc., as known in the art.

After each method block, the computing device proceeds to the “call merit function” block to use a merit function which evaluates each prospective loan against the user's goals, if provided. For example, the merit function may compute the net present value of the cost of servicing the loan inclusive of all financial flow related to the capital in question. This may include investment of excess cash, state and/or federal tax deductions for mortgage interest or student loan debt, etc. In some examples, debts of different types, including but not limited to student loan debt, auto loan debt, revolving debt, personal debt, etc., may be considered as well, such that these debts can also be co-optimized with respect to the loan, and the user can leverage and maneuver equity or debt into the most favorable APR categories as determined by the co-optimization.

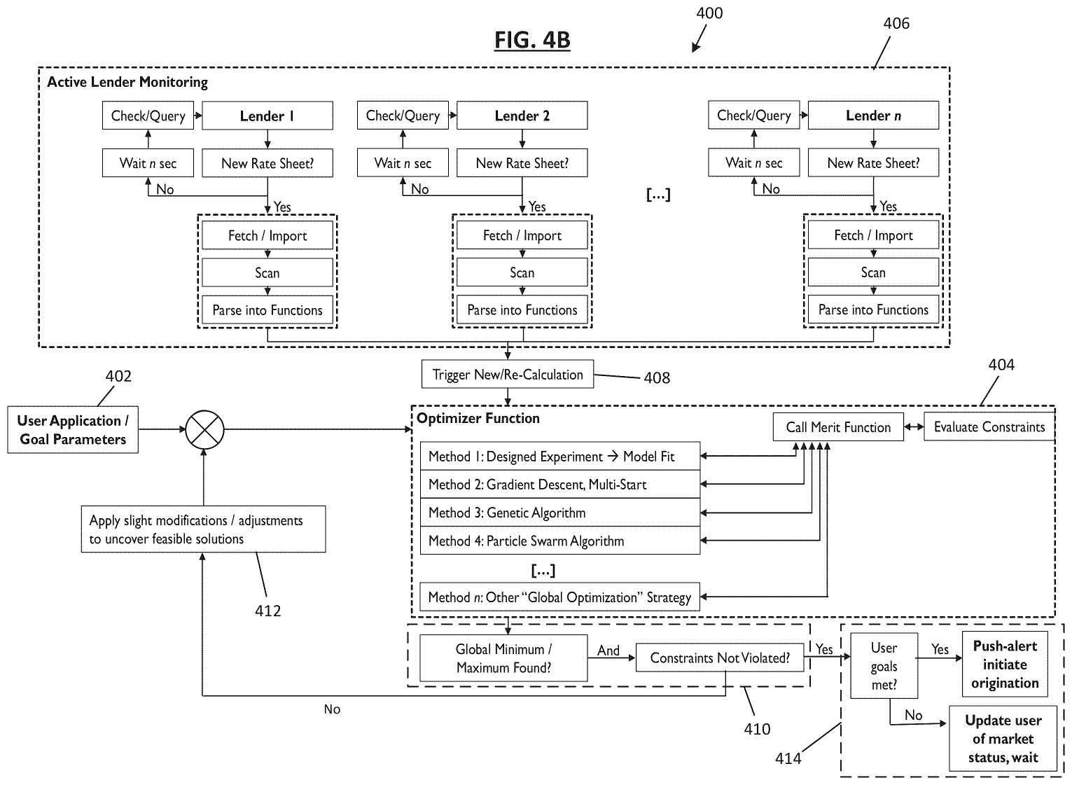

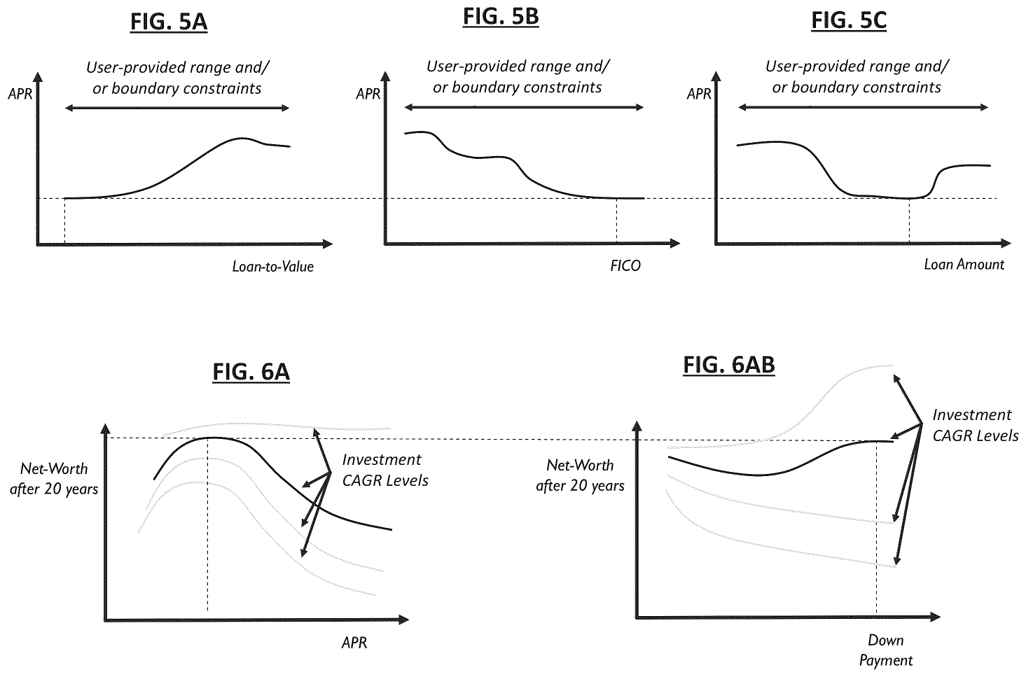

For example, if the user provided a single stated objective of achieving the lowest possible APR, the output would simply be the best evaluated APR. Further, if the user provided a range on certain input values, the output could be a table as well as a visual display showing the tradeoff of the lowest APR against each input range provided, as shown in FIGS. 5A through 5C.

In FIG. 5A, the user provides a range and/or a boundary constraints of LW ratios, in which the optimizer block 404 can freely navigate and apply different values therein to adjust the APR value associated therewith. FIG. 5B shows the user-provided range and/or boundary constraints of the FICO score for adjustment, and FIG. 5C shows the user-provided range and/or boundary constraints of the loan amount for adjustment. The user could optionally “slide” each input parameter left or right of the optimum to view the sensitivity to the objective function to the individual parameters.

FIGS. 6A and 6B show another possibility in which the user may optionally select multiple goals, in which case the response surfaces or pareto frontiers could be visually displayed to help the user decide which option would be the most suitable for the input values and ranges provided. For example, FIG. 6A shows four different curves of investment compound annual growth rate (CAGR) levels, with respect to the APR vs the net worth of the investment after 20 years, and FIG. 6B shows four different curves of investment CAGR levels, with respect to the initial down payment vs the net worth of the investment after 20 years. The bold dark curve in both figures represent the pareto frontier for the particular graph, and the user can visually see the maximum net worth that can be achieved at which APR and down payment values.

Returning to FIG. 4B, the computing device then uses the “evaluate constraint” block to evaluate whether the constraints have been exceeded based on the optimization methods, in the optimizer block 404. After the optimization, the computing device proceeds to block 410 and to either block 412 or 414, as previously explained, based on the determination of whether a global optimum (minimum or maximum, based on whether the goal is to minimize or maximize an output parameter) was found as well as whether the user's constraints were violated.

In some examples, the process performed may involve no optimization if the case involves scalar (single-variable) inputs and the user having only a single object, such as having the minimum monthly payment. In such cases, a full sweep-and-scan of the lender space may be sufficient. However, if any of the inputs are ranges or the user wants to explore multiple objectives (goals), sweeping each lender quickly becomes infeasible and thus optimization algorithms would be required. Such algorithms may include gradient descent, gradient descent with multiple-starting points, genetic algorithms, particle swarm algorithms, simulated annealing, etc., as known in the art.

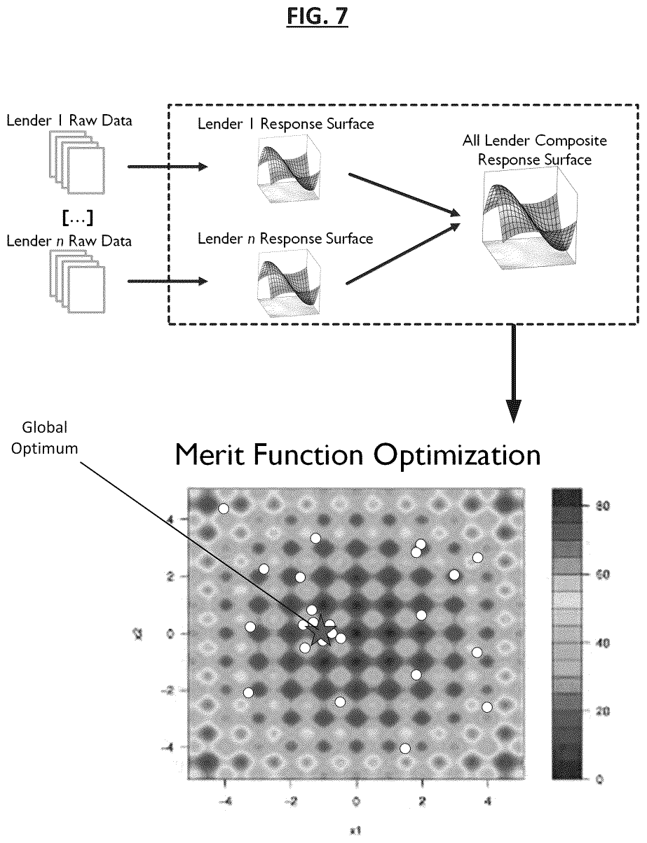

Additionally, depending on the complexity of each lender instruments (e.g., number of rate factors, tables, modifiers and qualifying parameters), the computing device performing the optimization could operate on the raw data from the lender (e.g., evaluate each case of the optimization directly), or alternatively a “response surface” or interpolation scheme could be fit prior to optimization in order to reduce the computational workload of each case evaluation as a starting point for approximation, with a final official evaluation of the optimum (or space near the optimum) to confirm true output values. An example of such response surfaces of different lenders is shown in FIG. 7. The response surfaces are combined together to generate an all-lender composite response surface, on which an optimization is performed in view of the merit function, as shown in the “Merit Function Optimization,” in which a global optimum is shown using a star near the middle of the graph.

As previously explained, the process of “shopping around” for loan products in the current market is difficult, if not impossible, due to the sheer size of the lending market. Because the lending market is massive and has hundreds if not thousands of lenders providing different “deals” which can change by the minute, it is unreasonable to expect that a broker could scan the full market and adjust the application parameters of the borrower to find the ideal option. New rates are published often multiple times a day from each lender, so in the time it takes for a broker to manually find the rates, new rate sheets may be generated which may disqualify (or newly qualify) the borrower to the loan product. Furthermore, without the numerical coupling of the application parameters through an optimization process tailored to the lender's specific loan product(s), it is impossible for the borrower to know whether he or she would otherwise qualify for loan product(s) that could have otherwise been filtered out due to one or more nominal application parameters.

As previously explained, the co-optimization of loans and debts of different types and sizes (the “primary” and “secondary” loans) can be implemented as well in the optimizer block 404, according to some examples. For example, the primary loan may be a mortgage of a house, and the secondary loan may be a personal loan, credit card loan, student debt, or car loan. Digitizing such loans and debts can open up new loan products for borrowers that would have otherwise been hidden due to one or more filter criteria.

For example, a user may have monthly payments to a student loan ($300) and a mortgage ($700). With an income of $2000 per month after tax, the user's debt-to-income is 50%, and a mortgage vehicle loan product has an upper cap of 43% (that is, the loan amount cannot be greater than an amount that would require monthly payment to be greater than 43% of the borrower's monthly income), so the user would not qualify. In a first option, the user could refinance the student loan to a longer duration thus lowering the student loan payment to $100 per month and open up a rate-term refinance on the home on the otherwise-inaccessible loan product. In a second option, the user could apply for cash-out refinancing on the mortgage (note that cash-out refinancing usually comes with a slightly higher APR), use the cash-out to pay off the student debt, and then apply for rate-term refinancing of the mortgage (with the lowest rate) on the new loan product that would have been opened up by performing this process. Either option (and many other proliferations) would save the borrower a considerable amount of money by reducing the overall APR and total interest costs. Many proliferations of this may exist when co-optimizing debts and loans.

In some examples, the optimizer block 404 includes generating a model of the market influencers such as Treasury Yield 10 Years (TNX, also referred to as “10-year yield”), secondary mortgage market, mortgage-backed securities, etc., that are known to affect rate sheet changes from lenders. Therefore, predictive models can be generated which can generate a predicted confidence factor which may be implemented by the computing device to generate a notification to the user regarding what actions the user must take in order to minimize the cost of debt and maximize the long-term wealth of the user.

In some examples, benefits of the optimization may include the generation of simple rate quotes for individual loan products (e.g., mortgage, student, etc.) by performing a full scan of the wholesale lending market with individually optimized application parameters as well as visualization and recommendations on options available to minimize cost of servicing the debt. The co-optimization of debts can also beneficially provide the users with options of lower APR loan products, and the computing device can generate the strategy that the user can take to be qualified for such loan products. The computing device can also generate strategies for serial financing or refinancing, with multiple steps to maneuver debts and loans. In some examples, liquidity providers can also benefit from optimization, as explained above, by providing the secondary loan to the user in order to allow the user to be qualified for a loan product (the primary loan) with a lower total cost of debt.

In some cases, rate querying and optimization may be done in the background on either a remote device 108 or client device 102, without a specific request from the client device 102. These results could be cached on either device for later use or stored on the remote device 108 to reduce workload and repetitive optimizations for loan queries that are common or anticipated based on market data and projected future trends.

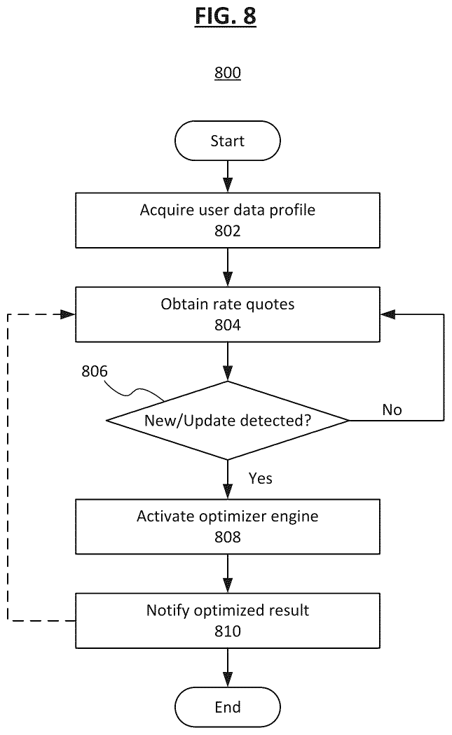

FIG. 8 shows a high-level flow diagram of an example of a method or process 800 which may be performed by a computing system including but not limited to a computing device such as the processor 104, as disclosed herein, for loan application optimization. In step 802, the system acquires a user data profile associated with the user requesting a loan. The user data profile may include the user's income, credit score, assets, and debt portfolio including existing liabilities held by the user. In some configurations, the user data profile may be imported to the system via any suitable means, for example via user input or downloading such information from a database. In some examples, the user data profile includes, but are not limited to, the user address, the user's desired loan amount, the user's income, the user's savings (such as liquid asset), etc. In step 804, the system obtains a plurality of rate quotes in response to acquiring the user data profile. For example, the system may automatically and/or continuously scan for any new or updated lender rate sheets via a routinely scheduled sweep-and-scan of the lender space performed at least once during any suitable period of time as determined by the system. If a new or updated rate quote(s) and/or lender rate sheet(s) is detected, as per step 806, the process proceeds to step 808, where the system activates the optimizer engine to perform the optimization process such as a merit-function optimization, multi-objective optimization, and/or any other suitable type of optimization calculation as disclosed herein. The optimization is performed to obtain an optimized result based on the user data profile and the rate quotes. Otherwise, in some examples, if there is no new or updated lender rate sheet(s) as determined in step 806, the process returns to step 804 for the next routine update or sweep-and-scan.

Once the optimizer engine is activated (e.g., to perform the merit function, optimization algorithm, and/or any other suitable type of optimization calculations as disclosed herein or as known in the art) and the suitable processes are completed, in step 810, information regarding the optimized result is notified to the user or displayed for the user's review. The displayed information may include a push-alert that notifies the user of the optimal loan product that is currently available in the market to suit the user's needs, as determined by the optimizer engine. Alternatively, the displayed information may include a notification to inform the user that the user's needs cannot be met in the current rate sheets provided by the market, so the user is recommended to wait until new or updated lender rate sheet(s) are provided, after which the optimizer engine can be activated again (as shown by the broken line from step 810 to step 804). In some examples, after the optimal loan product is displayed the user may be led to a separate window in which the user may proceed with the determined loan product, or the user may decide to wait for a better loan product to be determined in the future (in which case the process returns to step 804 as well).

In some examples, the acquiring of the user data profile in step 802 is triggered by a change to a value within the user data profile. The value may include one or more of: a bank account, a credit score, a new loan, or a property value that is associated with the user. For example, when the user updates any value which may affect the rate quotes, the step 802 is triggered in response to proceed with the subsequent steps as shown. In some examples, the acquiring of the user data profile in step 802 is repeatedly performed on a predetermined timeframe or a predetermined data schedule, such as to continuously update one or more values within the user data profile if a difference or change is detected. For example, the timeframe or schedule may include a new acquisition of the user data profile once every time interval. The time interval may be, for example, from 1 second to 10 seconds, from 10 seconds to 20 seconds, from 20 seconds to 30 seconds, from 30 seconds to 60 seconds, from 1 minute to 2 minutes, from 2 minutes to 5 minutes, from 5 minutes to 10 minutes, from 10 minutes to 15 minutes, from 15 minutes to 30 minutes, or any other value or range therebetween. In some examples, the user data profile may be manually acquired, such as when the user manually inputs or changes one or more values within the user data profile (e.g., via the user interface of the user device).

The rate quotes may also be obtained as per step 804 immediately after or in response to detecting a triggering market event, where the triggering market event may be any suitable event or parameter that is capable of influencing the rate quotes. For example, the triggering market event may be a fluctuation in the stock market, which may be indicated by, e.g., Dow Jones Industrial Average, S&P 500 Index, and/or NASDAQ Index, among others, such that the fluctuation which extends beyond a predetermined threshold value may trigger such process. In some examples, the market event may include rate sheet updates, Federal Reserve Board meetings, update on the 10-year treasury note, or change in a mortgage-backed security, among others.

In some examples, the rate quotes are obtained using a design of experiments (DOE) algorithm as further explained herein using degrees of freedom (DOF) determined by various factors/parameters which may affect the rate quotes. The DOE algorithm may be performed based on existing loans that are associated with the user, and in some examples further based on at least one additional loan which may be suggested by the DOE algorithm, for example according to the determined DOF. As part of the DOE algorithm, a loan request with parameters that are intentionally different from the existing loans and the additional loan as suggested may be used as well. The DOE algorithm may thus create or generate a number of rate quotes sweeping different parameters that may influence the rate quotes differently, including but not limited to the loan amount, FICO score, etc. Alternatively or additionally, the user may request an additional loan(s) that is implemented by the DOE algorithm in creating or generating the quotes, and in some examples further based on existing loans associated with the user.

In some examples, the rate quotes are obtained using a fitted numerical model which is trained, using any suitable means of training a machine learning model based on previously obtained rate quote data. After the model is trained, the model then provides the rate quotes in response to obtaining the user data profile as the input. In some examples, the training data may be obtained at any time prior to receiving the user data profile, or the training data may be obtained in response to receiving the user data profile such that the model is trained each time the user data profile is acquired or updated accordingly.

As referred to herein, an “asset” may include one or more of: a property owned by the user, and/or a bank/investment account associated with the user. As referred to herein, an “existing liability” may include one or more of: a mortgage, an auto loan, a personal loan, a student loan, and/or a credit card debt associated with the user.

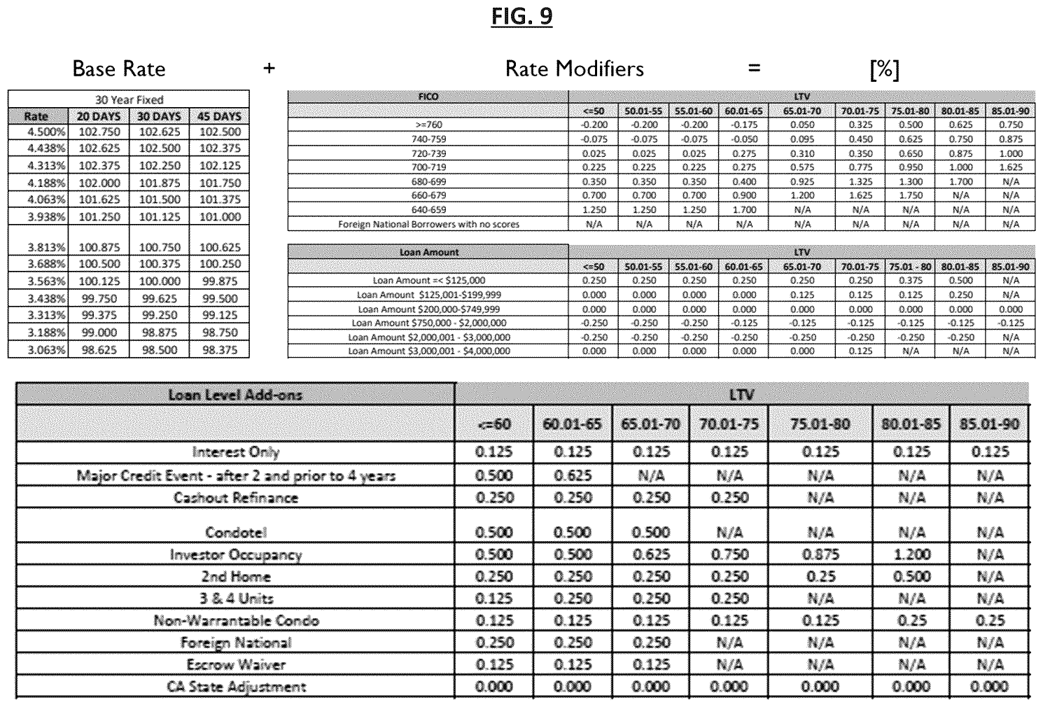

As referred to herein, a “rate sheet” is a sheet, for example a data table, either provided by the loan provider (including but not limited to mortgage providers) or created by the system, disclosing the loan provider's base rates and discrete rate modifiers that are used in APR calculations. For example, base rates may be shown in a table with a range of rates as well as the conditions necessary to obtain the particular rates (e.g., a lock period of 20/30/45 day in a fixed mortgage of a predetermined number of years). For example, rate modifiers may be shown in multiple tables where the columns represent the different LTV values and the rows represent the different ranges of a user's parameter. The user's parameter may include, but are not limited to, the user's FICO score or the user's desired loan amount, such that the rate modifier is determined by the selected LTV value and the user's parameter as initially inputted or obtained. An example of such rate sheets is shown in FIG. 9, which is to be referred to in the following APR calculation. As an example, if a user wishes to borrow a loan of $664,000 with 66% LW on a 30-year fixed APR and has a FICO score of 685, the base rate may be 3.563%, while a first rate modifier based on the user's FICO score and the 66% LW may add an additional 0.925%, and a second rate modifier based on the user's loan amount and the 66% LTV may add 0%, totaling a 4.50% APR (rounded). However, if the user lowers the LW to 65% (without changing the loan amount and the FICO score), the total calculated APR can be lowered to 4.00% because the 1% decrease in LW shifts the user to qualify for a different “bin” to the left on the rate sheet, which equates to a saving of $70,000 in the interest cost. In some examples, the optimized result as displayed to the user may include an optimal amount of down payment, an optimal amount to borrow, and/or an optimal length of time to repay the amount borrowed in view of the above, for example, which may equate to a saving in the interest cost. In some examples, the optimizer engine may implement the optimization based on existing loans associated with the user such that the loan balances of the existing loans may be restructured, eliminated, or consolidated, in order to provide the optimized result. In some examples, the optimizer engine may implement the optimization based on at least one additional loan as suggested by the processor using the DOE algorithm, where the optimizer engine uses asset balances (e.g., from a bank account of the user) to adjust loan amounts of the additional loan such that the loan balances of the existing loans are restructured, eliminated, or consolidated, in order to provide the optimized result. Also shown in FIG. 9 are some examples of additional loan-level add-ons in the rate modifiers, as suitable, including but not limited to any one or more of: whether the loan is for interest only, whether there is any major credit event (after 2 and prior to 4 years), whether the loan is for cash-out refinance, whether the loan is for condotel, whether there is investor occupancy, whether the loan is for a second home, whether the loan is for 3 and 4 units, whether the loan is for a non-warrantable condominium, whether the borrower is a foreign national, whether there is an escrow waiver, and/or any suitable state-based adjustment (e.g., California).

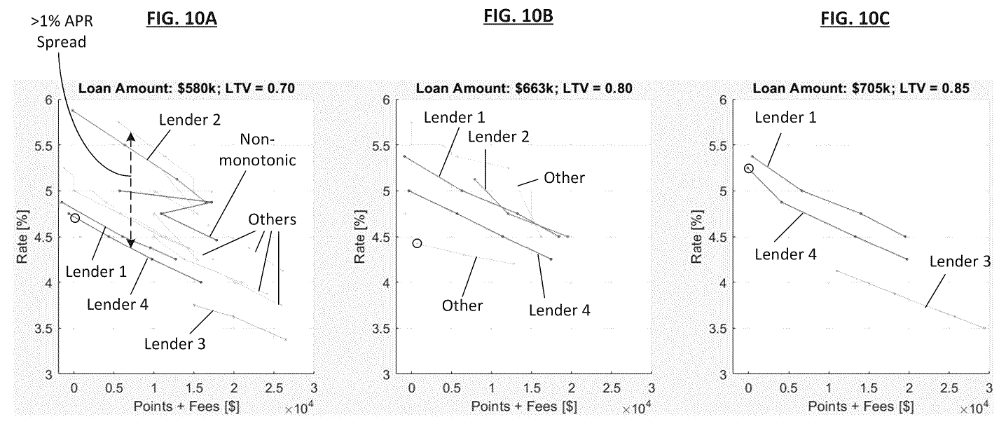

FIGS. 10A through 10C show the variance among the APRs offered by different lenders based on different conditions such as the loan amount and the LTV, for example. Throughout these figures, the circle shows the best zero-point rate in the group with the lowest APR at or near zero-point. A zero-point rate is defined as when the user can refinance a current mortgage to a different APR with no points and no fees charged by the loan provider. In these figures, only Lender 1 and Lender 4 offer loan products that span the full space between $580,000 and $705,000, and there are high lender-to-lender product type discrepancies such as jumbo, conforming, or Federal Housing Administration (FHA) loans, and the rates may be highly fragmented, incomplete, and/or inconsistent. For example, in FIG. 10A, a loan provider's rate may be non-monotonic, with a Z-shaped curve decreasing and increasing the points and fees as the APR is increased. In FIG. 10B, there is a cross-over between the rate curves of Lender 1 and Lender 2 between $12,000 and $16,000, for example, and Lender 3 is not present when the LTV is 0.8. In FIG. 10C, likewise, Lender 2 is not present when the LW is 0.85. Also, Lender 2 and Lender 3 do not offer any product at zero-point ($0 points and fees). From FIG. 10A to FIG. 10B, the user may lower the APR to borrow $80,000 more in loan amount, and the lowest cost to the borrower would fall between the loan amounts of $580,000 and $663,000 as shown in FIGS. 10A and 10B, respectively. FIG. 10A shows that, in some cases, the APR may vary by more than 1% between two lenders for the same amount of points and fees.

In some examples, the system acquires the borrower's (user's) objectives such as the financial information, limits on the down payment, and goals of the loan. In some examples, the merit function operates to minimize the net cost to service the debt, obtain the lowest rate when taking out the loan, and/or minimize the payment (such as the monthly payment), for example. The constraints may include the debt-to-income (DTI) ratio, cash reserves, monthly payment amount, and any other suitable constraint for the borrower. The optimizer engine may implement a design of experiments (DOE) using degrees of freedom (DOF) determined by factors/parameters including, but are not limited to, LW, points, FICO score, loan product type, and/or loan duration, among others, and computes the merit function and constraints. In some examples, the optimization may implement response surface as determined using a full factorial design. In some examples, the optimization may implement direct mathematic calculations to obtain the global optimum. In some examples, the global (direct) optimization includes a flexible optimization approach such as multi-start gradient descent or genetic algorithm, for example, as known in the art. The system may confirm the final rate by the lender using the lender's API. The optimization results in a single “best” solution via pareto frontier or tradeoffs for displaying via the user interface. The merit function and constraints are implemented, therefore, to minimize the cost of debt as constrained within the boundaries as defined by the user's inputted parameters.

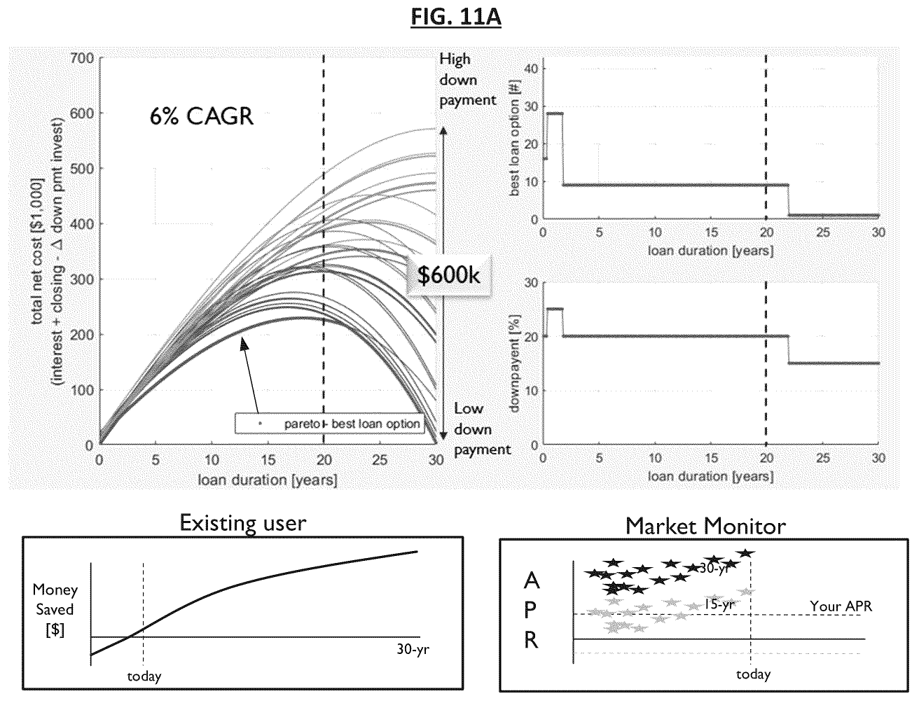

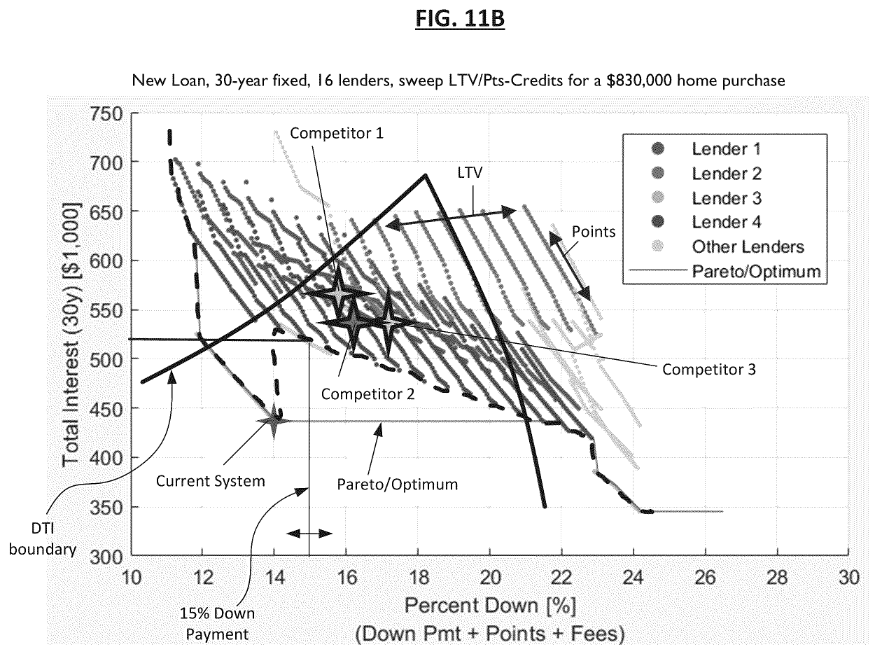

FIGS. 11A and 11B show some examples of how the data or information resulting from the optimization can be visualized according to some embodiments. For example, in the top left graph of FIG. 11A, the user is shown a comparison of the curves for loan duration vs total net cost for different loan products as analyzed, with the pareto curve being shown for comparison, for a compound annual growth rate (CAGR) of 6%, with the difference after 30 years being as varied as $600,000 between the pareto curve and the highest-costing curve, as shown. As such, in this example, the borrower may be able to realize a net-zero loan cost, if properly informed and encouraged to invest the excess amount. In the two windows on the right, the difference in the loan products and down payments are shown with the best values present at different loan hold durations. In the two windows below, a monitoring service is shown with a rate monitor on the right (market monitor) and the amount of money saved shown on the left (for the existing user) based on a 30-year plan starting today, showing the progress to a refinance goal that may be set by the user.

In FIG. 11B, the user can be presented with a comparison of how the global optimum (shown as a cross-shaped star) as determined using the current system fares in comparison with the “best product” as determined using competitors' systems (Competitors 1, 2, and 3; shown as cross-shaped stars) in terms of finding the loan product with the smallest amount of total interest, for example after 30 years in a 30-year fixed APR loan, in a graph comparing the percentage down payment vs total interest over the entire period of paying the loan. A line indicates the 15% down payment (which may be the borrower's preferred percentage), and the percentage may be decreased or increased to achieve the optimal value in terms of the total interest. The pareto/optimum curve is shown, as well as the DTI boundary of the user, the LW range, and the points range, as previously explained. The cash reserve boundary of the borrower (user) may also be shown, which may determine the maximal value for the percentage down payment (e.g., if the cash reserve boundary is around 20% down payment, any value above this percentage such as 22% or more may be disregarded). The user can also compare among different lenders (Lenders 1 through 4 as well as other lenders such as those smaller than Lenders 1 through 4).

As disclosed herein, the systems may be able to perform a time-variant holistic multi-loan optimization using the aforementioned method and process. For example, with a predetermined cash reserve and a DTI boundary, the debt portfolio optimization may implement factors such as the lenders and the types of loan products that are offered, the timing and finance sequencing for the borrower, the tax implications for the borrower, the overpayment allocation for the borrower, and the capital investment for the borrower. In the first phase, the optimization takes into consideration personal loans, automobile loans, student loans, and mortgage loans in comparison to the retirement savings, investment savings, and other types of savings for the borrower. In the second phase, the debt vehicles are co-optimized such that implementing the merit function affects the net lifetime cost of all the loans, and the optimization acts on multiple loan products. The debts can be restructured (paid off or refinanced) as a parameter in the DOF within the optimization. In the third phase, a time-variant optimization may be implemented such that the user can build a 10- to 30-year loan cost and strategy, project restructuring opportunities, and set goals with known APR-gating items such as the loan amount, home value, cash reserves, etc.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

What is claimed is:

1. A method for computer-implemented debt portfolio optimization, the method being implemented via one or more processors, the method comprising:
acquiring, by the one or more processors, a user data profile associated with a user, wherein the user data profile includes income, credit score, assets, and a debt portfolio including existing liabilities held by the user;
obtaining, by the one or more processors, a plurality of rate quotes in response to acquiring the user data profile;
activating, by the one or more processors, an optimizer engine to perform optimization to obtain an optimized result based on the user data profile and the rate quotes; and
notifying, on a user interface of a user device, the user of the optimized result, wherein the optimized result includes an optimum loan product or an optimum loan portfolio as determined by the optimizer engine.

2. The method of claim 1, wherein the plurality of rate quotes are obtained, by the one or more processors, using a design of experiments (DOE) algorithm to intentionally vary one or more loan parameters.

3. The method of claim 2, wherein the DOE algorithm is performed based on existing loans associated with the user.

4. The method of claim 3, wherein the DOE algorithm is performed further based on at least one additional new loan as suggested by the processor using the DOE algorithm or as requested by the user.

5. The method of claim 4, wherein the user data profile further includes a new loan request from the user, and the DOE algorithm is configured to vary parameters associated with one or more of the at least one additional new loan and the existing loans, to be intentionally different from one or more parameters of the user data profile as acquired.

6. The method of claim 5, wherein the optimization engine uses asset balances to adjust loan amounts of the one or more of the at least one additional new loan such that loan balances of the one or more of the at least one additional new loan and the existing loans are restructured, eliminated, or consolidated.

7. The method of claim 1, wherein the assets include at least one property owned by the user or at least one bank or investment account associated with the user.

8. The method of claim 1, wherein the existing liabilities include one or more of: mortgage, auto loan, personal loan, student loan, or credit card debt associated with the user.

9. The method of claim 1, wherein the plurality of rate quotes are obtained, by the one or more processors, by continuously scanning a lender space for rate sheets from one or more lenders to process into the plurality of rate quotes.

10. The method of claim 9, wherein the continuous scanning of the lender space is facilitated using a DOE algorithm.

11. The method of claim 9, wherein the lender space comprises at least 100 lenders each offering a plurality of different loan products.

12. The method of claim 1, wherein the plurality of rate quotes are obtained, by the one or more processors, using a numerical model that is trained on previously obtained rate quote data.

13. The method of claim 1, wherein the acquiring of the user data profile is triggered by a change to a value within the user data profile, the value including one or more of: a bank balance, credit score, new loan, or property value.

14. The method of claim 1, wherein the acquiring of the user data profile is repeatedly performed on a predetermined timeframe or a predetermined date schedule to continuously update one or more values within the user data profile.

15. The method of claim 1, wherein the acquiring of the user data profile is manually performed by the user changing one or more values within the user data profile.

16. The method of claim 1, wherein the plurality of rate quotes are obtained immediately in response to detecting a change to the user data profile.

17. The method of claim 1, wherein the plurality of rate quotes are obtained immediately in response to detecting a triggering market event occurs.

18. The method of claim 17, wherein the triggering market event includes a parameter that is capable of influencing the rate quotes.

19. The method of claim 1, wherein the user data profile further includes a new loan request from the user, and the optimization engine is configured to perform the optimization based on varying parameters associated with the new loan request and one or more new or existing loans of the user to be intentionally different from one or more parameters of the user data profile as acquired, wherein loan balances of the one or more existing loans are restructured, eliminated, or consolidated.

20. The method of claim 1, wherein the rate quotes are associated with a plurality of lenders in a lender space, and wherein the optimization is configured to:
calculate a plurality of local optima based on the plurality of rate quotes; and
based on the local optima as calculated, select a single global optimum using the user data as constraints, to be displayed as the optimized result.

21. The method of claim 20, wherein each of the local optima is a point of pareto optimality calculated by the optimizer engine.

22. The method of claim 21, wherein the pareto optimality is a high-order pareto frontier for a multi-objective constrained optimization.

23. The method of claim 20, wherein each local optimum of the plurality of local optima represents the optimized result for one lender from the plurality of lenders.

24. The method of claim 1, wherein the optimized result includes one or more of: an optimal amount of down payment, an optimal amount to borrow, or an optimal length of time to repay the amount borrowed.

25. The method of claim 1, wherein calculations for the optimization is performed at or near real-time.

26. The method of claim 1, wherein the one or more processors are configured to continuously obtain and update the plurality of rate quotes at a time interval from 1 minute to 30 minutes.

27. The method of claim 1, wherein the optimization includes a constrained merit-function optimization.

28. A non-transitory computer-readable storage medium storing instructions which, when executed by one or more processors, causes the processors to:
acquire a user data profile associated with a user, wherein the user data profile includes income, credit score, assets, and a debt portfolio including existing liabilities held by the user;
design an experiment consisting of a plurality of loans with intentionally-varied parameters in response to acquiring the user data profile;
obtain a plurality of rate quotes based on the designed experiment
activate an optimizer engine to perform optimization to obtain an optimized result based on the user data profile and the rate quotes; and
notify, on a user interface of a user device, the user of the optimized result, wherein the optimized result includes an optimum loan product or an optimum loan portfolio as determined by the optimizer engine.

29. The non-transitory computer-readable storage medium of claim 28, wherein the rate quotes are associated with a plurality of lenders in a lender space, and wherein the optimization is configured to:
calculate a plurality of local optima based on the plurality of rate quotes; and
based on the local optima as calculated, select a single global optimum using the user data as constraints, to be displayed as the optimized result.

30. The non-transitory computer-readable storage medium of claim 29, wherein each of the local optima is a point of pareto optimality calculated by the optimizer engine.

31. The non-transitory computer-readable storage medium of claim 29, wherein each local optimum of the plurality of local optima represents the optimized result for one lender from the plurality of lenders.

32. The non-transitory computer-readable storage medium of claim 28, wherein the optimized result further includes one or more of: an optimal amount of down payment, an optimal amount to borrow, or an optimal length of time to repay the amount borrowed.

33. The non-transitory computer-readable storage medium of claim 28, wherein calculations for the merit function optimization is performed at or near real-time.

34. The non-transitory computer-readable storage medium of claim 29, wherein the lender space comprises at least 100 lenders each offering a plurality of different loan products.

35. The non-transitory computer-readable storage medium of claim 28, wherein the one or more processors are configured to continuously obtain and update the plurality of rate quotes at a time interval from 1 minute to 30 minutes.

36. A computing system comprising:
a user device having a user interface associated with a user;
one or more processors operatively coupled with the user interface; and
a memory operatively coupled with the one or more processors and storing instructions which, when executed by the one or more processors, causes the processors to:
acquire a user data profile associated with the user, wherein the user data profile includes income, credit score, assets, and a debt portfolio including existing liabilities held by the user;
design an experiment consisting of a plurality of loans with intentionally-varied parameters in response to acquiring the user data profile;
obtain a plurality of rate quotes in response to the designed experiment;
activate an optimizer engine to perform optimization to obtain an optimized result based on the user data profile and the rate quotes; and
notify, on the user interface of the user device, the user of the optimized result, wherein the optimized result includes an optimum loan product or an optimum loan portfolio as determined by the optimizer engine.
